(19) United States
(12) Patent Application Publication
(10) Pub. No.: US 2017/0357537 A1
(43) Pub. Date: Dec. 14, 2017

(54) VIRTUAL MACHINE DISPATCHING METHOD, APPARATUS, AND SYSTEM

(71) Applicant: Alibaba Group Holding Limited, Grand Cayman (KY)

(72) Inventors: Zhengxiong Tian, Hangzhou (CN); Guotao Tan, Hangzhou (CN)

(21) Appl. No.: 15/616,774

(22) Filed: Jun. 7, 2017

(30) Foreign Application Priority Data
Jun. 8, 2016 (CN) 201610405015.5

(51) Int. Cl. G06F 9/50; G06F 3/06

(52) U.S. Cl. CPC G06F 9/5044; G06F 3/064; G06F 3/0683; G06F 3/0665; G06F 3/0604; G06F 3/0653; G06F 2209/501

(57) ABSTRACT

A virtual machine dispatching method is disclosed. The method includes selecting host machines having performance parameters satisfying preset allocation conditions of a virtual machine to be dispatched from a host pool; determining whether respective available spaces of disk blocks of the host machines are greater than or equal to a space of a virtual machine disk mounted to the virtual machine to be dispatched, and filtering to obtain one or more host machines of which one or more disk blocks have available spaces greater than or equal to the space of the virtual machine disk; and selecting a host machine as an available host machine from among the one or more host machines, allocating the virtual machine to be dispatched to the available host machine, and creating the virtual machine disk mounted to the virtual machine to be dispatched on a corresponding disk block of the available host machine.

### CROSS REFERENCE TO RELATED PATENT APPLICATION

This application claims foreign priority to Chinese Patent Application No. 201610405015.5 filed on Jun. 8, 2016, entitled “Virtual Machine Dispatching Method, Apparatus, and System”, which is hereby incorporated by reference in its entirety.

### TECHNICAL FIELD

The present disclosure relates to the field of network technologies, and in particular, to virtual machine dispatching methods, apparatuses, and systems.

### BACKGROUND

Currently, local disks on computing devices often use disk arrays (Redundant Array Of Independent Disks, RAID), such as a RAID card structure. In a process of creating a virtual machine (VM) on a host machine (Node Control, N.C.), a virtual machine dispatching system needs to allocate the virtual machine to the host machine (i.e., a local computing device) by means of dispatching. Since the host machine uses a RAID card structure, the host machine has only one disk block from the perspective of the virtual machine dispatching system, when a virtual machine is dispatched. When dispatching and selecting a host machine, only an overall performance of the host machine, for example, whether available resources of a CPU, memory, and disk are sufficient, is needed for consideration.

Currently, a virtual machine dispatching method may generally include filtering host machines in a host pool based on preset filtering conditions, with a main filtering condition including whether resources of a CPU, memory, and disk are sufficient for allocation of a virtual machine and a disk mounted to the virtual machine, and selecting one or more host machines meeting the conditions; calculating weight values of the host machines meeting the conditions according to a weighting algorithm, and sorting the host machines according to the weight values in a descending order, with a higher weight value representing a more superior host machine corresponding thereto; and selecting a host machine having a weight value being ranked among the top (for example, the highest weight value) for creating a virtual machine and a virtual machine disk mounted thereto.

For a virtual machine dispatching system, the RAID card structure is an integral disk block, and a total number of input/output (I/O) operations per second (i.e., IOPS) is limited by the RAID card. Moreover, the RAID card is relatively expensive, and the cost is relatively high.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

To solve the foregoing technical problem, the present disclosure provides a method and a system for dispatching a virtual machine, which can improve an IOPS capability of a local computing device, and to reduce device costs.

The present disclosure provides a virtual machine dispatching method. The method may include selecting one or more host machines having one or more performance parameters satisfying one or more preset allocation conditions of a virtual machine to be dispatched from a host pool; determining whether respective available spaces of disk blocks of the one or more host machines are greater than or equal to a space of a virtual machine disk mounted to the virtual machine to be dispatched, and filtering to obtain host machines of which disk blocks have available spaces greater than or equal to the space of the virtual machine disk; and selecting a host machine as an available host machine from among the host machines of which the disk blocks have available spaces greater than or equal to the space of the virtual machine disk, allocating the virtual machine to be dispatched to the available host machine, and creating the virtual machine disk mounted to the virtual machine to be dispatched on a corresponding disk block of the available host machine.

In implementations, the one or more performance parameters of the host machine may include at least one of a CPU processing capability or a memory space size.

In implementations, the one or more preset allocation conditions of the virtual machine to be dispatched may include at least one of a CPU processing capability or a memory space size of a host machine required for running the virtual machine to be dispatched.

In implementations, if only one virtual machine disk is mounted to the virtual machine to be dispatched, determining whether the respective available space of the disk blocks of the one or more host machines are greater than or equal to the space of the virtual machine disk mounted to the virtual machine to be dispatched, and filtering to obtain the host machines of which the disk blocks have the available spaces greater than or equal to the space of the virtual machine disk may include: determining whether multiple disk blocks of a particular host machine include a disk block having an available space being greater than or equal to the space of the virtual machine disk mounted to the virtual machine to be dispatched, and filtering to obtain the particular host machine if affirmative.

In implementations, if two or more virtual machine disks are mounted to the virtual machine to be dispatched, determining whether the respective available space of the disk blocks of the one or more host machines are greater than or equal to the space of the virtual machine disk mounted to the virtual machine to be dispatched, and filtering to obtain the host machines of which the disk blocks have the available spaces greater than or equal to the space of the virtual machine disk may include:
comparing a number of virtual machine disks that are mounted to the virtual machine and respective numbers of disk blocks in the one or more host machines, and removing a host machine having a number of disk blocks that is less than the number of virtual machine disks;
separately ordering respective spaces of the virtual machine disks and available spaces of disk blocks of host machines remained after comparison in a descending order;
determining whether the available spaces of the disk blocks are greater than or equal to the spaces of the virtual machine disks at corresponding positions after the ordering; and
filtering to obtain a host machine of which respective disk blocks all have available spaces greater than or equal to the spaces of the virtual machine disks at the corresponding positions.

In implementations, selecting the host machine as the available host machine from among the host machines of which the disk blocks have the available spaces greater than or equal to the space of the virtual machine disk may include:
calculating respective first weight values of the available spaces of the disk blocks in the host machines of which the disk blocks have the available spaces greater than or equal to the space of the virtual machine disk using a weighting algorithm;
calculating respective second weight values of the performance parameters of the host machines using the weighting algorithm; and
selecting a host machine having a maximum sum of a respective first weight value and a respective second weight value as the available host machine.

In implementations, the present disclosure further provides a virtual machine dispatching apparatus. The apparatus may include a first filtering unit configured to select one or more host machines having one or more performance parameters satisfying one or more preset allocation conditions of a virtual machine to be dispatched from a host pool; a determination unit configured to determine whether respective available spaces of disk blocks of the one or more host machines are greater than or equal to a space of a virtual machine disk mounted to the virtual machine to be dispatched; a second filtering unit configured to filter to obtain host machines of which disk blocks have available spaces greater than or equal to the space of the virtual machine disk according to a result determined by the determination unit; and a selection unit configured to select a host machine as an available host machine from among the host machines of which the disk blocks have available spaces greater than or equal to the space of the virtual machine disk, allocate the virtual machine to be dispatched to the available host machine, and create the virtual machine disk mounted to the virtual machine to be dispatched on a corresponding disk block of the available host machine.

In implementations, the one or more performance parameters of the host machine may include at least one of a CPU processing capability or a memory space size.

In implementations, the one or more preset allocation conditions of the virtual machine to be dispatched may include at least one of a CPU processing capability or a memory space size of a host machine required for running the virtual machine to be dispatched.

In implementations, if only one virtual machine disk is mounted to the virtual machine to be dispatched, the determination unit is further configured to determine whether multiple disk blocks of a particular host machine include a disk block having an available space being greater than or equal to the space of the virtual machine disk mounted to the virtual machine to be dispatched.

In implementations, if two or more virtual machine disks are mounted to the virtual machine to be dispatched, the determination unit may include:
a comparison module configured to compare a number of virtual machine disks that are mounted to the virtual machine and respective numbers of disk blocks in the one or more host machines, and remove a host machine having a number of disk blocks that is less than the number of virtual machine disks;
an ordering module configured to separately order respective spaces of the virtual machine disks and available spaces of disk blocks of host machines remained after comparison in a descending order; and
a determination module configured to determine whether the available spaces of the disk blocks are greater than or equal to the spaces of the virtual machine disks at corresponding positions after the ordering.

In implementations, the second filtering unit may further be configured to filter to obtain a host machine of which respective disk blocks all have available spaces greater than or equal to the spaces of the virtual machine disks at the corresponding positions.

In implementations, the selection unit may include:
a first weight calculation module configured to calculate respective first weight values of the available spaces of the disk blocks in the host machines of which the disk blocks have the available spaces greater than or equal to the space of the virtual machine disk using a weighting algorithm;
a second weight calculation module configured to calculate respective second weight values of the performance parameters of the host machines using the weighting algorithm; and
a weight selection module configured to select a host machine having a maximum sum of a respective first weight value and a respective second weight value as the available host machine.

The present disclosure further provides a virtual machine dispatching system, which may include the foregoing virtual machine dispatching apparatus, multiple host machines, and multiple virtual machines. In implementations, a host machine may include multiple disk blocks, and one or more virtual machine disks are mounted to a virtual machine.

The disclosed virtual machine dispatching method and system employ a multi-disk block structure which has no RAID card, and a dispatching system separately dispatches a host machine and multiple disk blocks therein, thus improving the IOPS capability of a created virtual machine disk, and also reducing the costs.

The disclosed virtual machine dispatching method and system further enable virtual machines and virtual machine disks to be allocated to host machines in a balanced manner through a weighting algorithm.

Other features and advantages of the present disclosure will be described in the following, and would either become apparent in the specification or be understood through implementations of the present disclosure. The objectives and other advantages of the present disclosure can be implemented and obtained through a structure particularly pointed out in the specification, claims, and accompanying drawings.

### BRIEF DESCRIPTION OF THE DRAWINGS

Accompanying drawings are used to provide further understanding of the technical solutions of the present disclosure, and form a part of the disclosure. Together with embodiments of the present disclosure, the accompanying drawings are used to illustrate the technical solutions of the present disclosure, and are not construed as limitations to the technical solutions of the present disclosure.

FIG. 1 is a flowchart of an example virtual machine dispatching method according to the present disclosure.

FIG. 2 is a structural diagram of a virtual machine dispatching system according to the present disclosure.

FIG. 3 is a structural diagram of a virtual machine dispatching apparatus according to a first embodiment of the present disclosure.

FIG. 4 is a structural diagram of a virtual machine dispatching apparatus according to a second embodiment of the present disclosure.

FIG. 5 is a structural diagram of the virtual machine dispatching apparatus as shown in FIGS. 3 and 4 in more detail.

### DETAILED DESCRIPTION

To make the objectives, technical solutions, and advantages of the present disclosure more clear, the embodiments of the present disclosure will be described in detail hereinafter with reference to the accompanying drawings. It should be noted that the embodiments in the present disclosure and features in the embodiments may be arbitrarily combined if no conflict exists.

Operations shown in a flowchart in the accompanying drawings may be executed as a group of computer executable instructions in a computer system, for example. Moreover, although a logical order is shown in the flowchart, the operations that are shown or described may be executed in an order different from the orders therein under some situations.

One of the ideas of the present disclosure includes providing a method and a system for dispatching a virtual machine. By performing dispatching and selection on host machines with performance parameters meeting one or more conditions first, dispatching and selection may then be performed on multiple disk blocks included in each host machine. A host machine that can be used for creating a virtual machine and a virtual machine disk may finally be determined based on results of these two levels of dispatching and selection.

In implementations, when creating a virtual machine (VM), the virtual machine dispatching system may need to dispatch and allocate a virtual machine to a specific host machine (NC). A local disk block (DEVICE) may be a local disk media (such as an SSD disk) on the host machine, and store all pieces of data of a VM that runs thereon. A virtual machine disk (DISK) may be a disk that is mounted to the virtual machine.

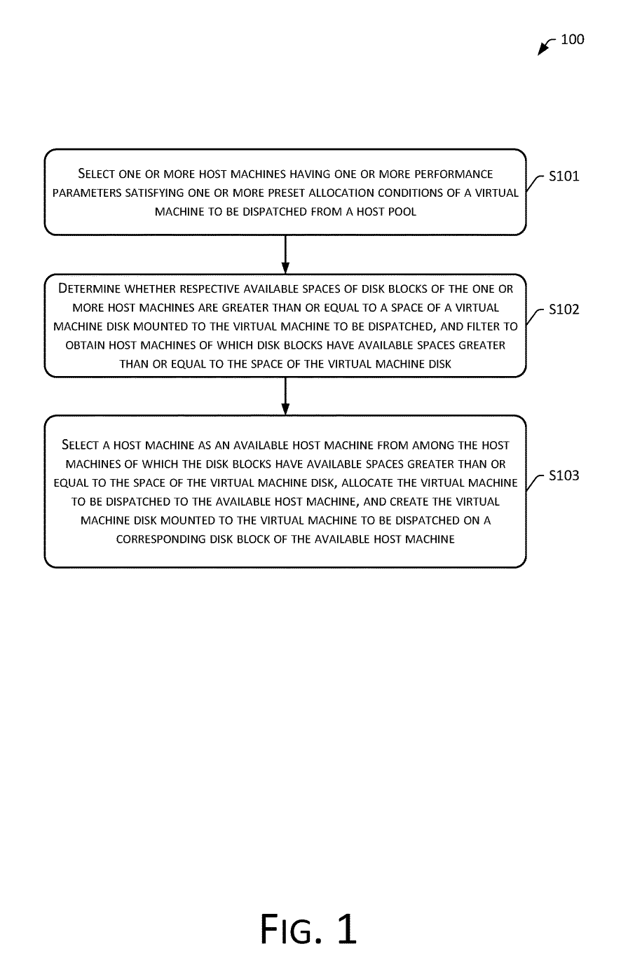

FIG. 1 is a flowchart of an example virtual machine dispatching method 100 according to the present disclosure. As shown in FIG. 1, the method 100 may include the following operations.

S101 selects one or more host machines having one or more performance parameters satisfying one or more preset allocation conditions of a virtual machine to be dispatched from a host pool.

S102 determines whether respective available spaces of disk blocks of the one or more host machines are greater than or equal to a space of a virtual machine disk mounted to the virtual machine to be dispatched, and filters to obtain host machines of which disk blocks have available spaces greater than or equal to the space of the virtual machine disk.

S103 selects a host machine as an available host machine from among the host machines of which the disk blocks have available spaces greater than or equal to the space of the virtual machine disk, allocates the virtual machine to be dispatched to the available host machine, and creates the virtual machine disk mounted to the virtual machine to be dispatched on a corresponding disk block of the available host machine.

In implementations, since a host machine may include multiple disk blocks, some host machines that fulfill one or more allocation conditions of a virtual machine are first selected according to performance of the host machines. For example, whether a CPU processing capability and a memory available space of a current host machine are sufficient for an allocation of a virtual machine to be dispatched. Based on a size of an available space of each disk block in each host machine, a determination may be made as to whether a virtual machine disk mounted to the virtual machine can be created on one or more disk blocks of the respective host machine, and host machines on which the virtual machine disk can be created are obtained by filtering. A host machine may then be determined for allocating the virtual machine and creating the virtual machine disk according to one or more defined rules.

The disclosed virtual machine dispatching method and system employ a multi-disk block structure without having a RAID card. A dispatching system dispatches a host machine and multiple disk blocks in the host machine, so that virtual machine disks can be created on multiple disk blocks in a single host machine, and read/write operations can be performed on the multiple disk blocks on which virtual machine disks are created at the same time, thus improving the IOPS capability of the virtual machine disks, and also reducing the costs because a RAID card is not needed.

An implementation is used hereinafter for describing the virtual machine dispatching method of the present disclosure in detail.

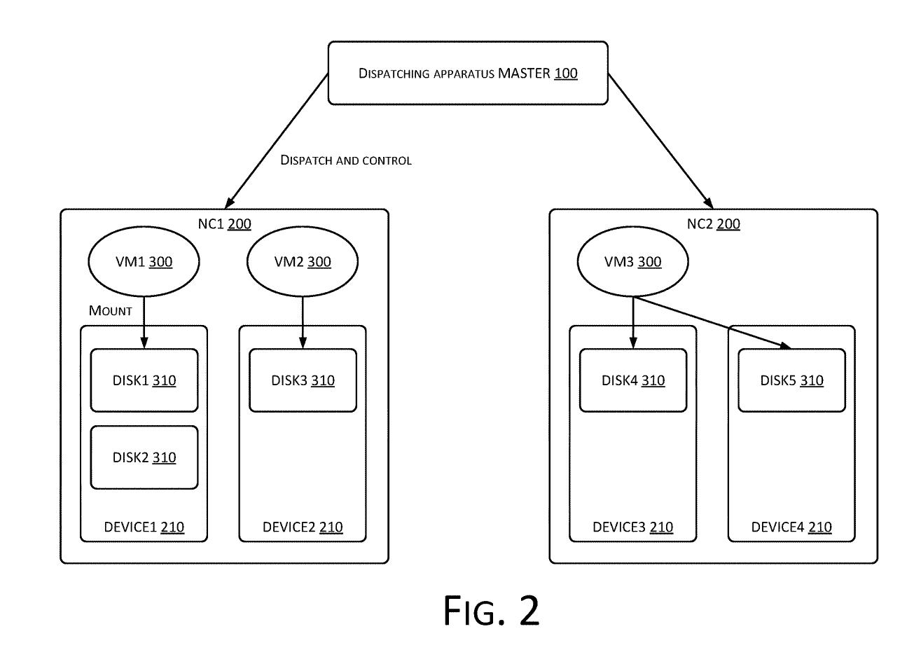

FIG. 2 is a structural diagram of a virtual machine dispatching system. As shown in FIG. 2, a virtual machine dispatching apparatus (MASTER) 100 dispatches three virtual machines (VMs) 300 to two or more host machines (NCs) 200. A single NC 200 may possess multiple disk blocks (DEVICEs) 210, and multiple disks (DISKs) 310 may be mounted to a single VM 300.

(1) The MASTER dispatches a VM1 to which a DISK1 is mounted, with an assumption that a NC1 and a NC2 are not allocated with any virtual machine yet.

The MASTER selects host machines having a CPU processing capability and a memory space size that satisfy running of the VM1 from a host pool. For example, the MASTER selects the NC1 and the NC2.

Only one DISK1 is mounted to the VM1, and the MASTER determines whether available spaces of DEVICEs in the NC1 and NC2 can be used for creating the DISK1 based on a space size of the DISK1, that is, whether a respective available space of each DEVICE in the NC1 and NC2 is greater than or equal to the space of the DISK1. After determination, the MASTER determines that a DEVICE1 and a DEVICE2 of the NC1, and a DEVICE3 of the NC2 each have an available space greater than the space of the DISK1, and can be used for creating the DISK1. In this case, the DEVICE1 and the DEVICE2 of the NC1 and the DEVICE3 of the NC2 are obtained by filtering.

According to a filtering order of host machines, the NC1 may directly be selected for allocating the VM1, and the DISK1 may be created on the DEVICE1 of the NC1, for example. Alternatively, a NC with a maximum weight value may be obtained through calculation based on a weighting algorithm, and used for allocating the VM. For example, first weight values of the available spaces of the DEVICE1, DEVICE2, and DEVICE3 may be individually calculated first. Second weight values may then be calculated according to CPU utilization rates and sizes of memory available spaces. The first weight values and the second weight values may further be combined, and the VM1 is allocated to the NC1 which has a maximum weight sum. Furthermore, corresponding first weight values of the DEVICE1 and DEVICE2 in the NC1 are compared, and the DEVICE1 having a greater weight value is selected to create the DISK1 that is mounted to the VM1.

(2) The MASTER dispatches a VM3 to which a DISK4 and a DISKS are mounted.

The MASTER selects host machines having a CPU processing capability and a memory space size that satisfy running of the VM1 from the host pool. For example, the MASTER selects the NC1, the NC2, and a NC3 (not shown).

By comparing the number of DISKs in the VM3 with respective numbers of DEVICEs included in the NC1, NC2, and NC3, the NC3 is found to include only one DEVICE. Therefore, the NC3 is eliminated. It should be pointed out that two DISKs are mounted to the VM3 in this example herein. If three DISKs are mounted to a VM, a NC having the number of DEVICEs been greater than or equal to three needs to be selected.

The DEVICEs in the NC1 and NC2, and the DISKs in the VM3 are ordered according to space sizes. For example, after ordering, available spaces of the DEVICEs in the NC1 are {DEVICE1, DEVICE2}={260, 100}, and available spaces of the DEVICEs in the NC2 are {DEVICE3, DEVICE4}={320, 80}. Moreover, the DISKs in the VM3 are {DISK4, DISK5}={310, 60} after ordering.

A determination is made as to whether the available spaces of the DEVICEs are greater than or equal to the spaces of the DISKs in the VM3 at corresponding positions after the ordering. For example, after comparing the space sizes in the foregoing example, the DEVICE3 in the NC2 can be used for creating the DISK4 that is mounted to the VM3, and the DEVICE4 in the NC2 can be used for creating the DISK5 that is mounted to the VM3.

Finally, the NC2 is selected for the allocation of the VM3, with the DISK4 being created on the DEVICE3, and the DISK5 being created on the DEVICE4. Apparently, if multiple NCs that can be used for the allocation of the VM3 are obtained after filtering, an optimal NC for allocation of the VM3 may be computed using a weighting algorithm or other algorithms, so that virtual machines and virtual machine disks are allocated to host machines in a balanced manner.

In the foregoing implementation, the virtual machine dispatching system may dispatch multiple virtual machines to a single host machine, i.e., a single host machine may run multiple virtual machines. A virtual machine disk can only be created on one disk block, and cannot be created across disk blocks. Moreover, a virtual machine and disk block(s) of the virtual machine need to be created on a same host machine.

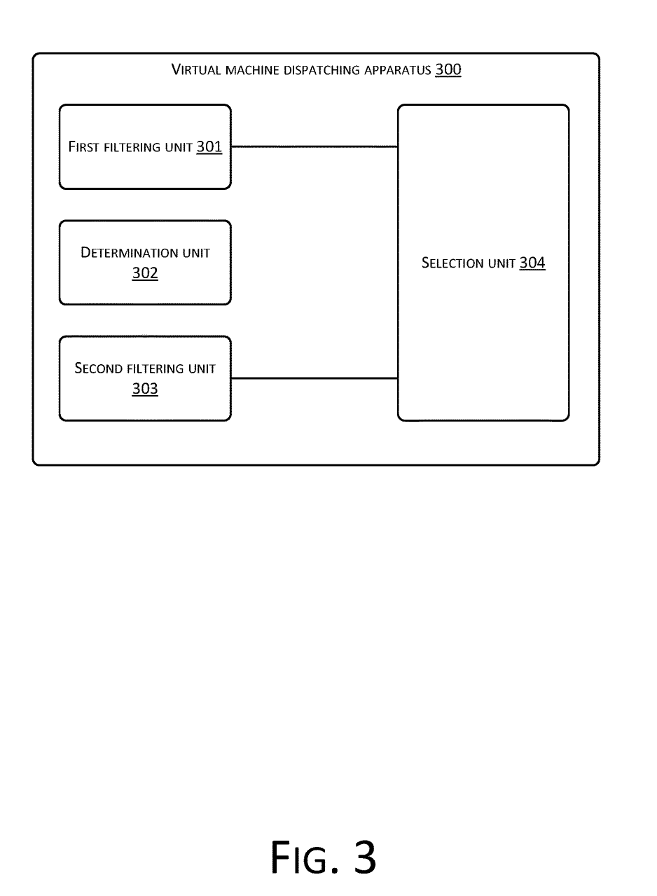

FIG. 3 is a structural diagram of a first example virtual machine dispatching apparatus 300 according to the present disclosure. As shown in FIG. 3, the apparatus 300 may include a first filtering unit 301, a determination unit 302, a second filtering unit 303, and a selection unit 304. The first filtering unit may select one or more host machines with one or more performance parameters meeting one or more preset allocation conditions of a virtual machine to be dispatched from a host pool. The determination unit 302 may determine whether an available space of each disk block of a host machine of the one or more host machines selected by the first filtering unit 301 is greater than or equal to a space of a virtual machine disk mounted to the virtual machine to be dispatched. The second filtering unit 303 may obtain host machines having one or more disk blocks that have available spaces greater than or equal to the space of the virtual machine disk according to a determination result of the determination unit 302. The selection unit 304 may select a host machine as an available host machine from among the host machines having the one or more disk blocks that have available spaces greater than or equal to the space of the virtual machine disk, allocate the virtual machine to be dispatched to the available host machine, and create the virtual machine disk mounted to the virtual machine to be dispatched on a corresponding disk block of the available host machine.

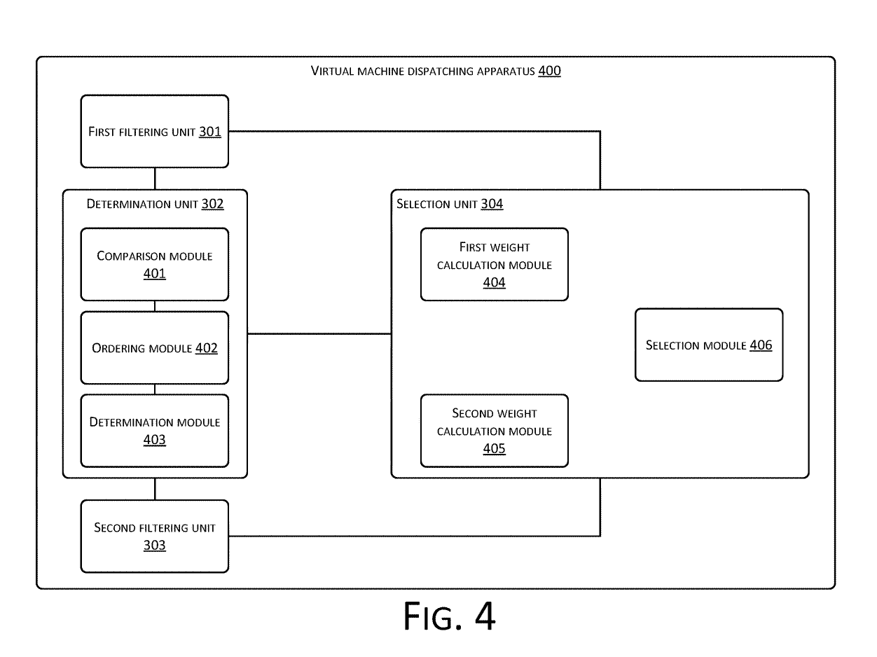

FIG. 4 is a structural diagram of a second example virtual machine dispatching apparatus 400 according to the present disclosure. As shown in FIG. 4, the virtual machine dispatching 400 may include the first filtering unit 301, the determination unit 302, the second filtering unit 303, and the selection unit 304 as shown in FIG. 3. The one or more performance parameters of a host machine may include at least one of a CPU processing capability or a memory space size. The one or more preset allocation conditions of the virtual machine to be dispatched may include at least one of a CPU processing capability or a memory space size of a host machine required for running the virtual machine to be dispatched.

In an event that only one virtual machine disk is mounted to the virtual machine to be dispatched, the determination unit 302 may further determine whether multiple disk blocks of an available host machine include a disk block with an available space being greater than or equal to the space of the virtual machine disk mounted to the virtual machine to be dispatched.

Alternatively, in an event that two or more virtual machine disks are mounted to the virtual machine to be dispatched, the determination unit 302 may include: a comparison module 401 configured to compare a number of virtual machine disks that are mounted to the virtual machine and respective numbers of disk blocks in the one or more host machines, and remove a host machine having a number of disk blocks that is less than the number of virtual machine disks; an ordering module 402 configured to separately order respective spaces of the virtual machine disks and available spaces of disk blocks of host machines remained after comparison in a descending order; and a determination module 403 configured to determine whether the available spaces of the disk blocks are greater than or equal to the spaces of the virtual machine disks at corresponding positions after the ordering.

In implementations, the second filtering unit 303 may further be configured to filter to obtain a host machine of which respective disk blocks all have available spaces greater than or equal to the spaces of the virtual machine disks at the corresponding positions.

In implementations, the selection unit 304 may include a first weight calculation module 404 configured to calculate respective first weight values of the available spaces of the disk blocks in the host machines of which the disk blocks have the available spaces greater than or equal to the space of the virtual machine disk using a weighting algorithm; a second weight calculation module 405 configured to calculate respective second weight values of the performance parameters of the host machines using the weighting algorithm; and a weight selection module 406 configured to select a host machine having a maximum sum of a respective first weight value and a respective second weight value as the available host machine.

The disclosed virtual machine dispatching method and system employ a multi-disk block structure which has no RAID card, and a dispatching system separately dispatches a host machine and multiple disk blocks therein, thus improving the IOPS capability of a created virtual machine disk, and also reducing the costs. The disclosed virtual machine dispatching method and system further enable virtual machines and virtual machine disks to be allocated to host machines in a balanced manner through a weighting algorithm.

Apparently, any product for implementing the present disclosure does not need to achieve all the foregoing advantages.

In a typical configuration, a computing device may include one or more central processing units (CPUs), one or more input/output interfaces, one or more network interfaces, and memory. For example, the virtual machine dispatching apparatuses 300 and 400 may include one or more computing devices.

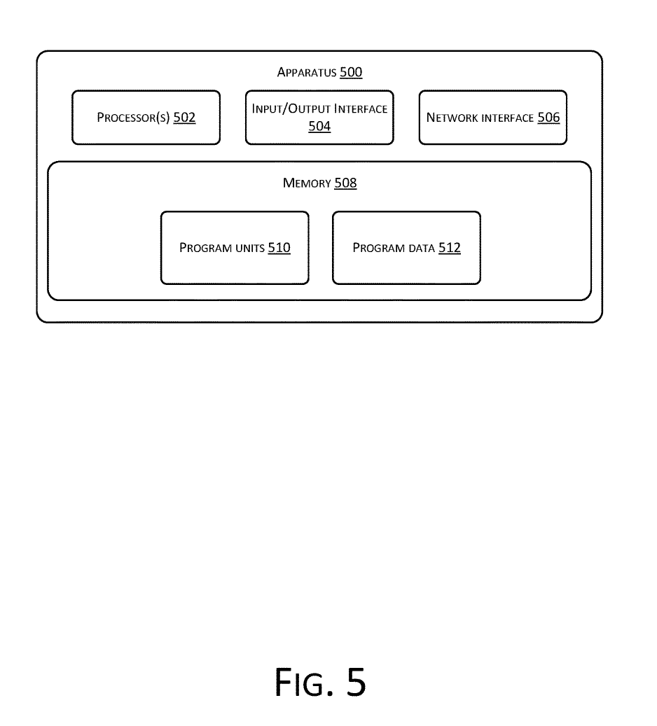

FIG. 5 shows a structural diagram of the virtual machine dispatching apparatus 500 such as apparatuses 300 and 400 shown in FIGS. 3 and 4 in further detail. By way for example and not limitation, the virtual machine dispatching apparatus 500 may include one or more processors 502, an input/output (I/O) interface 504, a network interface 506, and memory 508.

The memory 508 may include a form of computer-readable media, e.g., a non-permanent storage device, random-access memory (RAM) and/or a nonvolatile internal storage, such as read-only memory (ROM) or flash RAM. The memory 508 is an example of computer-readable media.

The computer-readable media may include a permanent or non-permanent type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer-readable media does not include transitory media, such as modulated data signals and carrier waves. For the ease of description, the system is divided into various types of units based on functions, and the units are described separately in the foregoing description. Apparently, the functions of various units may be implemented in one or more software and/or hardware components during an implementation of the present disclosure.

The memory 508 may include program units 510 and program data 512. The program units 510 may include one or more of the foregoing units of the apparatus 300 or 400 as described in the foregoing description.

Although the implementations disclosed in the present disclosure are described above, the described content merely represents implementations used for helping an understanding of the present disclosure rather than limiting the present disclosure. One skilled in the art may make various modifications and changes on the implementations in forms and details without departing from the spirit and scope disclosed in the present disclosure. The patent scope of protection of the present disclosure shall still be subject to the scope defined by the appended claims.

What is claimed is:

1. A method comprising:
selecting host machines having one or more performance parameters satisfying one or more preset allocation conditions of a virtual machine to be dispatched from a host pool;
selecting a particular host machine as an available host machine from among one or more host machines having respective one or more disk blocks that have available spaces greater than or equal to a space of a virtual machine disk mounted to the virtual machine to be dispatched, allocating the virtual machine to be dispatched to the available host machine, and creating the virtual machine disk mounted to the virtual machine to be dispatched on a corresponding disk block of the available host machine.

2. The method of claim 1, wherein the one or more preset allocation conditions comprise at least one of a CPU processing capability or a memory space size of a host machine required for running the virtual machine to be dispatched.

3. The method of claim 1, wherein selecting the particular host machine as the available host machine from among the one or more host machines comprises:
determining whether respective available spaces of disk blocks of the host machines are greater than or equal to the space of the virtual machine disk; and
obtaining the one or more host machines having the respective one or more disk blocks that have the available spaces greater than or equal to the space of the virtual machine disk.

4. The method of claim 3, wherein only one virtual machine disk is mounted to the virtual machine to be dispatched, and wherein determining whether the respective available spaces of the disk blocks of the host machines are greater than or equal to the space of the virtual machine disk mounted to the virtual machine to be dispatched comprises determining whether multiple disk blocks of a host machine of the host machines comprise a disk block having an available space greater than or equal to the space of the only one virtual machine disk mounted to the virtual machine to be dispatched.

5. The method of claim 3, wherein two or more virtual machine disks are mounted to the virtual machine to be dispatched, and wherein determining whether the respective available spaces of the disk blocks of the host machines are greater than or equal to the space of the virtual machine disk mounted to the virtual machine to be dispatched comprises comparing a number of virtual machine disks that are mounted to the virtual machine and respective numbers of disk blocks in the host machines, and removing a host machine having a number of disk blocks that is less than the number of virtual machine disks.

6. The method of claim 5, wherein determining whether the respective available spaces of the disk blocks of the one or more host machines are greater than or equal to the space of the virtual machine disk mounted to the virtual machine to be dispatched further comprises:
separately ordering respective spaces of the two or more virtual machine disks and available spaces of disk blocks of remaining host machines after the comparing in a descending order;
determining whether the available spaces of the disk blocks are greater than or equal to the spaces of the two or more virtual machine disks at corresponding positions after the ordering; and
filtering to obtain a host machine with respective disk blocks having available spaces greater than or equal to the spaces of the two or more virtual machine disks at the corresponding positions.

7. The method of claim 1, wherein selecting the host machine comprises:
calculating respective first weight values of the available spaces of the disk blocks in the one or more host machines using a weighting algorithm;
calculating respective second weight values of respective performance parameters of the one or more host machines using the weighting algorithm; and
selecting a host machine having a sum of a respective first weight value and a respective second weight value to be maximum as the available host machine.

8. An apparatus comprising:
one or more processors;
memory;
a first filtering unit stored in the memory and executable by the one or more processors to select at least host machine having one or more performance parameters satisfying one or more preset allocation conditions of a virtual machine to be dispatched from a host pool;
a selection unit stored in the memory and executable by the one or more processors to select a host machine as an available host machine from among one or more host machines of which disk blocks have available spaces greater than or equal to a space of a virtual machine disk mounted to the virtual machine to be dispatched, allocate the virtual machine to be dispatched to the available host machine, and create the virtual machine disk on a corresponding disk block of the available host machine.

9. The apparatus of claim 8, wherein the one or more preset allocation conditions comprise at least one of a CPU processing capability or a memory space size of a host machine required for running the virtual machine to be dispatched.

10. The apparatus of claim 8, wherein further comprises:
a determination unit stored in the memory and executable by the one or more processors to determine whether available spaces of disk blocks of the at least one host machine are greater than or equal to the space of the virtual machine disk mounted to the virtual machine to be dispatched; and
a second filtering unit stored in the memory and executable by the one or more processors to filter to obtain the one or more host machines of which the disk blocks have the available spaces greater than or equal to the space of the virtual machine disk according to a result determined by the determination unit.

11. The apparatus of claim 10, wherein only one virtual machine disk is mounted to the virtual machine to be dispatched, and the determination unit is further configured to determine whether multiple disk blocks of a particular host machine comprise a disk block having an available space greater than or equal to the space of the only one virtual machine disk mounted to the virtual machine to be dispatched.

12. The apparatus of claim 10, wherein two or more virtual machine disks are mounted to the virtual machine to be dispatched, and the determination unit comprises:
a comparison module configured to compare a number of virtual machine disks that are mounted to the virtual machine and respective numbers of disk blocks in the one or more host machines, and remove a host machine having a number of disk blocks that is less than the number of virtual machine disks;
an ordering module configured to separately order respective spaces of the virtual machine disks and available spaces of disk blocks of host machines remained after comparison in a descending order; and
a determination module configured to determine whether the available spaces of the disk blocks are greater than or equal to the spaces of the virtual machine disks at corresponding positions after the ordering.

13. The apparatus of claim 8, wherein the selection unit comprises:
a first weight calculation module configured to calculate respective first weight values of the available spaces of the disk blocks in the one or more host machines of which the disk blocks have the available spaces greater than or equal to the space of the virtual machine disk using a weighting algorithm;
a second weight calculation module configured to calculate respective second weight values of the performance parameters of the one or more host machines using the weighting algorithm; and
a weight selection module configured to select a host machine having a maximum sum of a respective first weight value and a respective second weight value as the available host machine.

14. One or more computer-readable media storing executable instructions that, when executed by one or more processors, cause the one or more processors to perform acts comprising:
selecting host machines having one or more performance parameters satisfying one or more preset allocation conditions of a virtual machine to be dispatched from a host pool;
selecting a particular host machine as an available host machine from among one or more host machines having respective one or more disk blocks that have available spaces greater than or equal to a space of a virtual machine disk mounted to the virtual machine to be dispatched, allocating the virtual machine to be dispatched to the available host machine, and creating the virtual machine disk mounted to the virtual machine to be dispatched on a corresponding disk block of the available host machine.

15. The one or more computer-readable media of claim 14, wherein the one or more preset allocation conditions comprise at least one of a CPU processing capability or a memory space size of a host machine required for running the virtual machine to be dispatched.

16. The one or more computer-readable media of claim 14, wherein selecting the particular host machine as the available host machine from among the one or more host machines comprises:
determining whether respective available spaces of disk blocks of the host machines are greater than or equal to the space of the virtual machine disk; and
obtaining the one or more host machines having the respective one or more disk blocks that have the available spaces greater than or equal to the space of the virtual machine disk.

17. The one or more computer-readable media of claim 16, wherein only one virtual machine disk is mounted to the virtual machine to be dispatched, and wherein determining whether the respective available spaces of the disk blocks of the host machines are greater than or equal to the space of the virtual machine disk mounted to the virtual machine to be dispatched comprises determining whether multiple disk blocks of a host machine of the host machines comprise a disk block having an available space greater than or equal to the space of the only one virtual machine disk mounted to the virtual machine to be dispatched.

18. The one or more computer-readable media of claim 16, wherein two or more virtual machine disks are mounted to the virtual machine to be dispatched, and wherein determining whether the respective available spaces of the disk blocks of the host machines are greater than or equal to the space of the virtual machine disk mounted to the virtual machine to be dispatched comprises comparing a number of virtual machine disks that are mounted to the virtual machine and respective numbers of disk blocks in the host machines, and removing a host machine having a number of disk blocks that is less than the number of virtual machine disks.

19. The one or more computer-readable media of claim 18, wherein determining whether the respective available spaces of the disk blocks of the one or more host machines are greater than or equal to the space of the virtual machine disk mounted to the virtual machine to be dispatched further comprises:
separately ordering respective spaces of the two or more virtual machine disks and available spaces of disk blocks of remaining host machines after the comparing in a descending order;
determining whether the available spaces of the disk blocks are greater than or equal to the spaces of the two or more virtual machine disks at corresponding positions after the ordering; and
filtering to obtain a host machine with respective disk blocks having available spaces greater than or equal to the spaces of the two or more virtual machine disks at the corresponding positions.

20. The one or more computer-readable media of claim 14, wherein selecting the host machine comprises:
calculating respective first weight values of the available spaces of the disk blocks in the one or more host machines using a weighting algorithm;
calculating respective second weight values of respective performance parameters of the one or more host machines using the weighting algorithm; and
selecting a host machine having a sum of a respective first weight value and a respective second weight value to be maximum as the available host machine.
